(19) United States
(12) Patent Application Publication
(10) Pub. No.: US 2023/0197925 A1
(43) Pub. Date: Jun. 22, 2023

(54) SYSTEM AND METHODS FOR A PRELITHIATED ELECTRODE FOR AN ELECTROCHEMICAL CELL

(71) Applicant: Solid Power Operating, Inc., Louisville, CO (US)

(72) Inventors: Rose E. RUTHER, Lafayette, CO (US); Ian A. MORRISSEY, Boulder, CO (US); Kristen T. HIETALA, Boulder, CO (US)

(21) Appl. No.: 18/083,929

(22) Filed: Dec. 19, 2022

Related U.S. Application Data
(60) Provisional application No. 63/265,669, filed on Dec. 17, 2021.

(51) Int. Cl. H01M 4/04; H01M 4/38

(52) U.S. Cl. CPC H01M 4/0435; H01M 4/382; H01M 2004/021

(57) ABSTRACT

Aspects of the present disclosure relate to prelithiating an electrode of an electrochemical cell to counteract lithium loss as an electrochemical cell is formed and cycled. One implementation may include a method comprising a) providing an electrode composite with lithium-ion conductivity and diffusivity, the electrode composite comprising a silicon-containing material, a carbon-based conductive additive, a solid electrolyte, and a binder; b) disposing a continuous thin layer of lithium proximate to the electrode composite; and c) pressure laminating the continuous thin layer of lithium to the electrode composite. Through the process, lithium is transferred to the solid-state electrode composite by contacting the lithium metal film with the electrode composite without the use of a liquid medium traditionally used to aid in the movement of lithium ions.

### CROSS-REFERENCE TO RELATED APPLICATION

This application is related to and claims priority under 35 U.S.C. § 119 from U.S. Provisional Application No. 63/265,669, filed Dec. 17, 2021, entitled “Prelithiated Negative Electrodes for Electrochemical Cells and Method for Making Same,” the entire contents of which is fully incorporated by reference herein for all purposes.

### TECHNICAL FIELD

Various embodiments described herein relate to the field of solid-state primary and secondary electrochemical cells, electrodes and electrode materials, electrolyte, and electrolyte compositions and corresponding methods of making and using same.

### BACKGROUND

The ever-increasing number and diversity of mobile devices, the evolution of hybrid/electric automobiles, and the development of Internet-of-Things devices is driving greater need for battery technologies with improved reliability, capacity (Ah), thermal characteristics, lifetime and recharge performance. Currently, although lithium solid-state battery technologies offer potential increases in safety, packaging efficiency, and enable new high-energy chemistries as compared to other types of batteries, improvements in lithium battery technologies and other solid-state battery technologies are needed.

It is with these observations in mind, among others, that aspects of the present disclosure were conceived.

### SUMMARY

Aspects of the present disclosure relate to electrochemical electrode materials, assembly, and processing to improve energy density and cycle life of electrochemical cells by providing a reservoir of lithium ions in an electrode (such as an anode of the electrochemical cell) to counteract lithium loss as an electrochemical cell is cycled, also referred to as to herein as “prelithiation” of the electrode. In some implementations, the present disclosure thus relates to a method of synthesizing a prelithiated electrode composite for an electrochemical cell. The method comprises: a) providing an electrode composite with lithium-ion conductivity and diffusivity, the electrode composite comprising a silicon-containing material, a carbon-based conductive additive, a solid electrolyte, and a binder; b) disposing a continuous thin layer of lithium proximate to the electrode composite; and c) pressure laminating the continuous thin layer of lithium to the electrode composite.

Another aspect of the present disclosure relates to a method for manufacturing a battery electrode. The method may include the operations of disposing a continuous layer of lithium adjacent to the electrode composite of the electrode stack and pressing the continuous layer of lithium to the electrode composite to prelithiate the electrode composite with at least a portion of the continuous layer of lithium.

Another aspect of the present disclosure relates to a solid-state electrochemical cell. The solid-state electrochemical cell may include a first electrode, a solid-state electrolyte adjacent the first electrode, and a second electrode adjacent the solid-state electrolyte, wherein the second electrode is prelithiated by dry laminating a continuous layer of lithium to a second electrode composite.

Yet another aspect of the present disclosure relates to a method for manufacturing a battery electrode. The method may include the operation of compressing an electrode stack comprising an electrode composite, a current collector, and a continuous layer of lithium adjacent to the electrode composite, wherein at least a portion of the continuous layer of lithium is absorbed by the electrode composite during the compression to prelithiate the electrode composite.

In some implementations, pressure laminating of a pressure in the range of 1,500 to 100,000 psi may be used to prelithiate the electrode. In another embodiment, the laminating pressure is maintained for a duration of between 0.01 and 600 minutes. In yet another embodiment, the laminating pressure is removed subsequent to the pressure laminating for a duration of between 0.01 and 600 minutes, with a duration in the range of 1 to 60 minutes.

In an embodiment, the laminated layer of lithium has a thickness in the range of 0.1 to 20 microns.

In an embodiment, the laminated layer of lithium includes a lithium alloy.

In an embodiment, the laminated layer of lithium is deposited upon a carrier. The carrier can comprise copper foil.

In yet another embodiment, the method further comprises removing the carrier foil from the prelithiated electrode composite.

In an embodiment, the pressure laminating occurs at a temperature in the range of 0 to 180° Celsius.

In an embodiment, the method further comprises monitoring the state of lithiation during the pressure laminating.

In an embodiment, the pressure laminating is carried out through of roll-to-roll calendering device.

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 is a diagram illustrating manufacturing a prelithiated electrode using a calender press, according to aspects of the present disclosure.

FIGS. 2A and 2B are simplified cross-sections of prelithiated electrodes for an electrochemical cell, according to aspects of the present disclosure.

FIG. 3 is a flow chart of a method for prelithiation of an electrode composite for an electrochemical cell, according to aspects of the present disclosure.

FIG. 4 is a is a diagram illustrating manufacturing a prelithiated electrode using a calender press and a peeler device, according to aspects of the present disclosure.

FIG. 5 illustrates a graph of discharge capacity versus a number of cycles of the electrochemical cell including both a first prelithiated anode and a first non-prelithiated anode.

FIG. 6 illustrates a graph of discharge capacity versus a number of cycles of the electrochemical cell including both a second prelithiated anode and a second non-prelithiated anode.

FIG. 7 illustrates a graph of discharge capacity versus a number of cycles of the electrochemical cell including a first prelithiated anode, a second prelithiated anode, and a non-prelithiated anode.

FIG. 8 illustrates representative cross-sections of an electrode stack through a process for forming a prelithiated electrode for an electrochemical cell that includes a carrier foil adjacent to a lithium layer, according to aspects of the present disclosure.

FIG. 9 illustrates representative cross-sections of an electrode stack through a process for forming a prelithiated electrode for an electrochemical cell that includes a passivation layer, according to aspects of the present disclosure.

FIG. 10 illustrates a cross-section of an electrochemical cell, according to aspects of the present disclosure.

### DETAILED DESCRIPTION

Aspects of the present disclosure relate to prelithiating an electrode of an electrochemical cell (such as an anode of the cell) to counteract lithium loss that may occur when the electrochemical cell is cycled. Previous electrode lithiation techniques of conventional liquid electrolyte electrochemical cells involve performing a formation step during an initial cycle or cycles of an assembled cell. During formation, lithium is transferred from a cathode of the cell, through the electrolyte, to the anode during one or more formation cycles involving charge and discharge. However, due to the chemical composition of the components of the electrochemical cell, a portion of the lithium ions deposited in the anode are lost, which is often referred to as first cycle efficiency of the electrochemical cell. The lithium loss that occurs during the formation step lowers the overall efficiency of the electrochemical cell as the number of lithium ions transferred through the electrolyte during a discharge directly impacts the efficiency of the cell.

The disclosure describes a method and system for prelithiation of an electrode composite for a solid-state lithium-ion electrochemical cell. In general, the method may include transferring lithium to an electrode of an electrochemical device to prelithiate the electrode with the lithium. In some instances, a thin (typically <10 micron) film of lithium metal may be used as the source of lithium. Lithium is transferred to the solid-state electrode composite by contacting the lithium metal film with the electrode composite. The process occurs against the electrode prior to assembly in a solid-state cell. Additionally, the process does not involve a liquid electrolyte or more generally the use of a liquid medium conventionally used to aid in the movement of lithium ions in a liquid electrolyte cell. The film may be pressed against the electrode. In one example, the system involves a calendering process where the film is pressed to the electrode, to facilitate the transfer of the lithium of the metal film to the electrode. Advantageously, solid state electrode composites may contain a solid electrolyte and may therefore be good conductors of lithium-ions without any liquids. This characteristic of solid-state electrode composites enables a unique, rapid, dry process for prelithiation which supports scalability of uniform prelithiation over large areas.

In one implementation, the method may comprise: a) providing an electrode composite (e.g., anode) with lithium-ion conductivity and diffusivity; b) disposing a continuous thin layer of lithium proximate the electrode composite; and c) pressure laminating the continuous thin layer of lithium to the electrode composite.

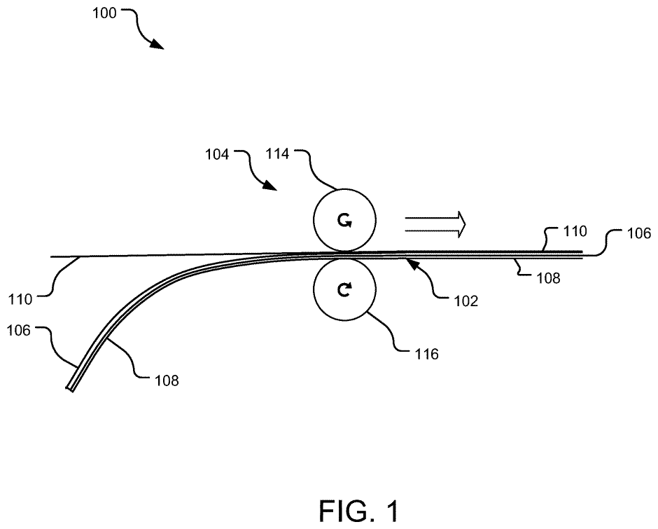

FIG. 1 is a diagram 100 illustrating a system for manufacturing a prelithiated electrode 102 using a calender press device 104, according to aspects of the present disclosure. While embodiments are described that involve a calender press, other mechanisms of pressing the lithium into the electrode are possible such a hydraulic press, mechanical press, pneumatic press, electro-mechanical or other type of presses. In one implementation, the prelithiated electrode 102 may include an electrode composite 106, a metal current collector 108, and a lithium-containing layer 110. It should be noted that the electrode that is used in a cell will include the electrode composite prelithiated with lithium from the lithium containing layer and the current collector recognizing that the lithium containing layer is ultimately removed.

In some implementations, the electrode composite 106 may comprise, for example, a composite material including an active material made of silicon metal, a solid-state electrolyte material, a carbon-based conductive additive, and one or more polymers as binding agents. The current collector layer 108 may include a thin metal foil, such as copper or stainless steel. The lithium-containing layer 110 may be a source of lithium metal or lithium metal alloy including a thin sheet or foil. In some instances, the lithium-containing layer 110 may also be lithium metal or alloy deposited on a carrier material such as a copper foil or other material where the lithium does not form an alloy with the carrier material. The electrode composite 106 may also, in some instances, be coated on a thin carrier film, such as a copper foil or other material. More or fewer layers, including other combinations of layers and compositions of layers, may be used for other types of electrodes. Further, the electrodes described herein may be negative electrodes (or anode) or positive electrodes (or cathodes) of an electrochemical device.

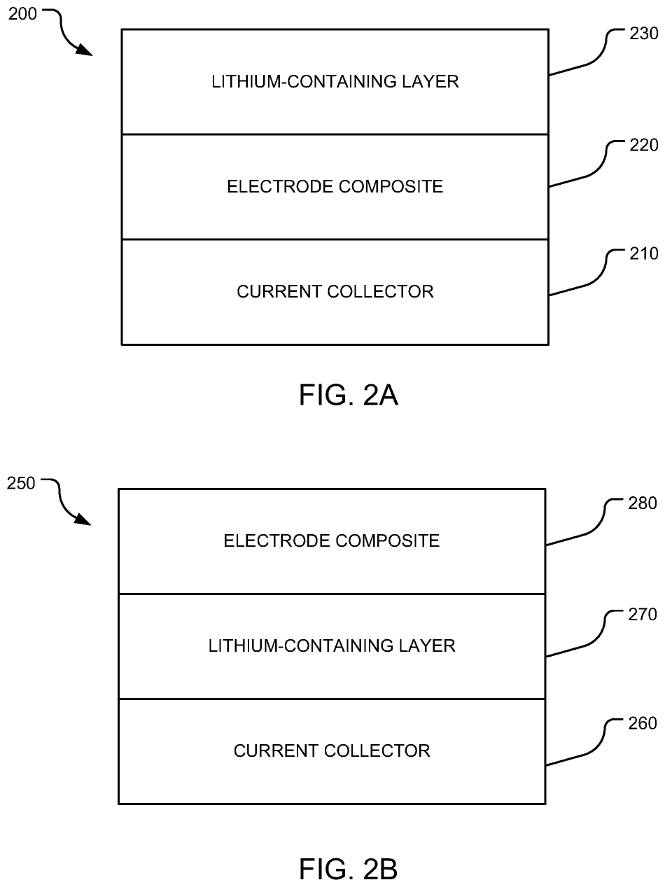

To produce the prelithiated electrode 102, the layers described above may be fed through a calender press device 104 in a Lithium-Electrode-Collector layered stack. In some implementations, the prelithiated electrode 102 may comprise an Electrode-Lithium-Collector layered stack. The various prelithiated electrodes stacks are described in more detail below with reference to FIGS. 2A-2B. The calender press 104 may comprise a first roller 114 and a second roller 116 between which the prelithiated electrode 102 may be passed. The opposing cylindrical faces of the respective rollers 114, 116 exert a compressive pinching force on the prelithiated electrode 102 to press the layers together. In one implementation, the pressure exerted on the stack 102 may cause at least a portion of the lithium layer to be absorbed into the electrode layer 106 to prelithiate the electrode layer. The prelithiation of the electrode layer through the pressure applied to the stack may alter or eliminate the conventional formation step discussed above. In other words, the electrode 106 may be prelithiated with lithium ions such that conservation of said lithium ions in the electrochemical device is maintained during charging and discharging of the electrochemical device.

The pressure applied to the stack 102 may correlate to the spacing 118 between the first roller 114 and the second roller 116, among other factors such as temperature of the stack. The spacing may be fixed or may be adjustable and may be adjustable by a controller, in some instances. For example, the controller may increase or decrease a distance between the rollers 114, 116 to ensure prelithiation of the electrode layer 106 by the lithium-containing layer 110. For example, a thicker lithium-containing layer 110 and/or electrode layer 106 may correspond to an increase in the spacing between the calender press rolls 114, 116. Thinner layers of the electrode stack 102 may correspond to a decrease in the spacing between the calender press rolls. In some instances, the spacing of the calender press 104 may be adjustable based on feedback information received from the rollers 114, 116 or other sensory components (such as force measurements, thickness of the layers measurements, temperature of the layers, etc.) associated with the manufacturing of the prelithiated electrode 102.

FIGS. 2A and 2B are simplified cross-sections of example electrode stacks 102 for an electrochemical cell prior to pressing. After pressing, at least a portion of the lithium from the lithium-containing layer may be absorbed into the electrode composite layer to prelithiate the electrode composite layer. Example electrode 200 of FIG. 2A comprises a current collector 210, an electrode composite 220, and a lithium-contain layer 230 stacked in a current collector-electrode-lithium configuration. Example electrode 250 of FIG. 2B comprises a current collector 260, an electrode composite 280, and a lithium-contain layer 270 in a current collector-lithium-electrode configuration. Electrodes 200 and 250 are similar but the arrangement of the layers and specifically the relative placement of the lithium-containing layers are different. However, in either case, the lithium-containing layer may be adjacent the electrode layer such that lithium ions from the lithium-containing layer may be absorbed into the electrode composite layer, either before, during, or after calendering of the stack. In particular, while some of the lithium ions of the lithium-containing layer may be absorbed into the electrode composite layer upon contact, calendering may aid in the further dispersion of lithium ions into the electrode composite layer.

In some implementations, current collectors 210 and 260 may be thin metal foils, such as copper or stainless steel. Electrode composites 220 and 280 may be, for example, a composite material including an active material made of silicon metal, a solid-state electrolyte material, a carbon-based conductive additive, and one or more polymers as binding agents. The composition of the electrode composites 220, 280 generally provides the composite with sufficiently high ionic and electronic conductivity to support rapid lithiation of the composite, especially a silicon-based material. The polymer(s) and/or binder(s) may be used to support the continued cohesion of the composite upon prelithiation since, as a silicon material lithiates, it may expand up to 300% of its original non-lithiated volume. The electrode composite 220, 280 may be formulated to support desired ionic and electronic conductivity, structural integrity to withstand lamination pressures of up to 100,000 psi, and the expansion and contraction that the electrode composite will undergo while cycling during use of the electrochemical cell that it is included within.

The electrode composite 220, 280 may generally include silicon or a compound thereof, a carbon-based conductive additive, solid electrolyte, and/or a binder material. Proportionally and in one example, the electrode composite 220, 280 may include at least 30% by weight of the silicon or the compound thereof; between 0% to 15% by weight of the carbon-based conductive additive; between 0% to 70% by weight of the solid electrolyte, and between 0% to 20% by weight of the binder. In an example electrode composite 220, 280, the solid electrolyte may be completely absent leaving only active material (Si), conductive additive (carbon), and a binding agent (polymer/binder).

More specifically, the silicon or a compound thereof included in the electrode composite 220, 280 may include elemental silicon, silicon dioxide, coated silicon, and coated silicon dioxide. Coatings for the silicon or silicon compound may include carbon-based shells, oxide-based shells where the oxides are Al₂O₃, ZrO₂ or the like, and sulfide bases shells where the sulfides are Li₂S or sulfide electrolytes such as Li₃PS₄, Li₇P₃S₁₁, or Li₆PS₅Cl. As described herein, generation and persistence of the morphological modifications of the composite is a function of the volume expansion of the silicon-based material and the cohesive resilient properties of the binder. To support the volume expansion and similar chemical compatibility, other materials that exhibit a volume expansion similar to silicon may be substituted in place of silicon. Germanium (Ge) and Tin (Sn) undergo similar volume expansion through their lithiation process where Ge expands ˜280% and Sn expands ˜257%. These materials or other intercalation-based materials may be fully or partially substituted for the silicon-based material.

Binders or polymers useful for inclusion into the electrode composite 220, 280 may be one or more of a fluorine-containing binder such as polyvinylene difluoride (PVdF) and the like. In another embodiment, the binder may contain fluororesins such as vinylidene fluoride (VdF), hexafluoropropylene (HFP), tetrafluoroethylene (TFE), and derivatives thereof as structural units. Specific examples thereof include homopolymers such as poly (vinylene difluoride-hexafluoropropylene) copolymer (PVdF-HFP), polyhexafluoropropylene (PHFP) and binary copolymers such as copolymers of VdF and HFP. In yet another embodiment, the binder may be one or more selected from a thermoplastic such as but not limited to polystyrene, polyethylene, polypropylene, polycarbonate, and polyvinyl chloride. In a further embodiment, the binder may be one or more selected from a thermoplastic-elastomer such as but not limited to styrene-butadiene rubber (SBR), styrene butadiene styrene copolymer (SBS), poly(styrene-isoprene-styrene) copolymer (SIS), poly(styrene-ethylene-butylene-styrene) copolymer (SEBS) polyacrylonitrile (PAN), nitrile-butylene rubber (NBR), polybutadiene, polyisoprene, Poly (methacrylate) nitrile-butadiene rubber (PMMA-NBR) and the like. In yet another embodiment, the binder may be one or more selected from an acrylic resin such as but not limited to polymethyl (meth) acrylate, polyethyl (meth) acrylate, polyisopropyl (meth) acrylate polyisobutyl (meth) acrylate, polybutyl (meth) acrylate, and combinations thereof. Any specific binder or combination and its concentration within the composite may be adjusted to support generally uniform segmentation and fracture generation as well as long term cohesion of the composite under cycling to ensure electron/ion mobility. The binder selection also supports the adhesion of the composite to the current collector, and partially determines the rheological properties of the slurry.

The carbon-based conductive additive of the electrode composite 220, 280 may be one or more of vapor-grown carbon fiber (VGCF), carbon black, acetylene black, activated carbon, furnace black, carbon nanotube, Ketjen Black, graphite such as natural graphite or artificial graphite, and graphene. The carbon-based conductive additive works in conjunction with the solid electrolyte material to evenly distribute the charge density throughout the composite by regulating the distribution of electrons throughout the volume of the composite.

The solid electrolyte may be one or more of Li₂S—P₂S₅, Li₂S—P₂S₅—LiI, Li₂S—P₂S₅—LiBr, Li₂S—P₂S₅—LiCl, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZnSn (where m and n are positive numbers, and Z is Ge, Zn or Ga), Li₂S—GeS₂, Li₂S—S—SiS₂—Li₃PO₄, and Li₂S—S—SiS₂-LiₓMO_{y} (where x and y are positive numbers, and M is P, Si, Ge, B, Al, Ga or In). Specific exemplary electrolyte materials may be one or more of Li₃PS₄, Li₄P₂S₆, Li₆PS₇, Li₇P₃S₁₁, Li₁₀GeP₂S₁₂, Li₁₀SnP₂S₁₂. In another embodiment the electrolyte material may be one or more of Li₆PS₅Cl, Li₆PS₅Br, Li₆PS₅I or Li_{7-y}PS_{6-y}X_{y} where “X” represents at least one halogen elements and or pseudo-halogen and where 0≤y≤2.0 and where the halogen may be one or more of F, Cl, Br, I, and a pseudo-halogen may be one or N, NH, NH₂, NO, NO₂, BF₄, BH₄, AlH₄, CN, and SCN. In yet another embodiment the electrolyte material may be one or more of a Li_{6-y-x}P₂S_{9-y-z}X_{y}W_{z} where “X” and “W” represents at least one halogen elements and or pseudo-halogen and where 0≤y≤1 and 0≤z≤1 and where a halogen may be one or more of F, Cl, Br, I, and a pseudo-halogen may be one or N, NH, NH₂, NO, NO₂, BF₄, BH₄, CN, and SCN. In yet a further embodiment, the electrolyte material may be one or more of a Li₄PS₄X, Li₄GeS₄X, Li₄SbS₄X, and Li₄SiS₄X where “X” represents at least one halogen elements and or pseudo-halogen and where a halogen may be one or more of F, Cl, Br, I, and a pseudo-halogen may be one or N, NH, NH₂, NO, NO₂, BF₄, BH₄, AlH₄, CN, and SCN. The solid electrolyte material, when mixed with a binder, may form a flexible matrix. The carbon additive and the silicon-containing material may then be suspended in this matrix. The flexible matrix provides the composite with the ability to maintain particle-to-particle contact while the silicon-containing material expands and contracts under cycling.

Lithium-containing layers 230, 270 may be a source of lithium metal or lithium metal alloy in the form of a thin sheet or foil. Layers 230, 270 may also be lithium metal or alloy deposited on a carrier material, such as a copper foil or other material where the lithium does not form an alloy with the carrier material. In one example, a lithium-containing layer 230, 270 may be a layer of lithium ranging from 0.1 to 35 um (microns) thick upon a layer of copper foil as a carrier. In some particular implementations, the lithium-containing layer 230, 270 may be a layer of lithium ranging from 0.1 to 20 microns. In some examples, the lithium may be laminated to the electrode composite 220, 280 by application of pressures in the range of 4000 to 8000 psi, such as through the calender press 140 discussed above. Furthermore, this configuration limits extrusion of the lithium outside of the original bounds of the interface between the electrode composite 220, 280 and the lithium layer 230, 270 during pressure lamination. An additional benefit of using a carrier for the lithium is that the lithium may be restricted from adhering to or reacting with the device that is applying the laminating force. For example, the carrier foil for the lithium-containing layer 230, 270 may prevent the upper roller 114 or the lower roller 116 of the calender press 104 during lamination of the stack 102. Post lithiation of the electrode composite layer 220, 280, the carrier foil may be free of lithium metal allowing for the removal of the carrier foil from the surface of the lithiated electrode composite without damaging the electrode. In some embodiments, the lithiation of the electrode composite layer 220, 280 may remove substantially all the lithium from the carrier. For example, after prelithiation, 99% or more lithium from the carrier will be transferred to electrode, so that 1% or less of the total lithium will remain on the carrier. In another embodiment, the carrier foil may contain greater than 1% but less than 5% lithium after the lithiation of the silicon containing layer. As such, in some examples between 95% and 99% of the lithium on the carrier is transferred to the electrode. In FIG. 2B where the lithium-containing layer 270 is located between the current collector 260 and the electrode composite layer 280, the electrode composite may be formed into a slurry and casting/coating onto a film of lithium on copper. The cast layer may then be dried to remove any solvents that were in the slurry and laminated/densified to ensure proper compaction of the layer and to start the lithiation process.

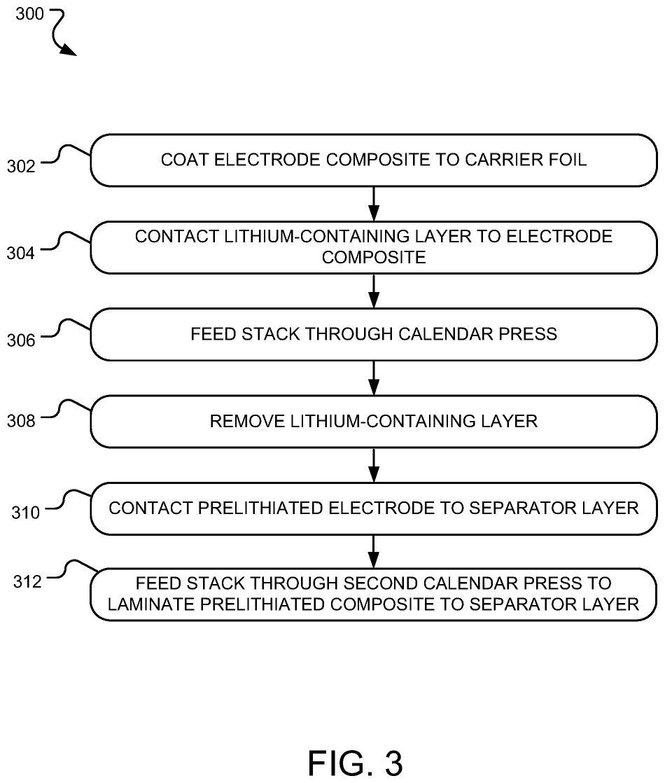

FIG. 3 is a flow chart of a method 300 for prelithiation of an electrode composite for an electrochemical cell, according to aspects of the present disclosure. Beginning in operation 302, any required or desired preparation of the various layers of the electrode stack 102 discussed above may be performed, such as but not limited to, electrode preparation and electrode densification. In one particular example, the electrode composite may be coated onto a carrier foil to create the electrode composite layer 220, 280. In other implementations, the electrode composite layer 220, 280 may not include a carrier foil. The compositions of the electrode composite layer 220, 280 and/or the carrier foil are discussed in more detail above. Further, in some examples, a lithium-containing layer 230, 270 may also be coated onto a carrier foil.

In operation 304, a lithium-containing layer 230, 270 and the electrode composite layer 220, 280 may be brought into contact. Specifically, a lithium bearing surface of the lithium-containing layer 230, 270 and a silicon bearing surface of the electrode composite layer 220, 280 may be contacted to promote the lithiation process of the electrode composite layer. After contact is made, pressure may be applied to the contacted layers to facilitate the lithiation process of the electrode composite layer 220, 280. In one particular implementation, the contacted layers may be fed through a calender press device 104 to apply the pressure to the electrode stack 102. In some examples, the applied pressure from the calender 104 may establish a compressive force in the range of 1,000 psi to 150,000 psi such that the lithium of the lithium-containing layer 230, 270 is laminated to and pressed into the surface of the electrode composite layer 220, 280. In another example, the pressure may be in the range of 2,000 to 125,000 psi. In a further example, the pressure may be in the range of 3,000 psi to 100,000 psi. In yet another example, the pressure may be in the range of 4,000 psi to 75,000 psi. In yet another example, the pressure may be in the range of 4,500 psi to 50,000 psi. In a further example, the pressure may be in the range of 5,000 to 25,000 psi. The pressure may be applied to the electrode stack 102 unidirectionally to either of the contacted layers or bidirectionally to both contacted layers or intermediate surfaces. In many instances, the pressure may be applied mechanically, hydraulically, or pneumatically through any pressing device and may be either uniform or spatially varied, with the calender device 104 one example of such a pressure device. In general, pressures above 1500 psi may enhance the rate of diffusion of the lithium into the electrode composite layer 220, 280. This effect is due to an increase in ionic and electronic conductivity of the electrode composite which results from greater particle-particle contact between the silicon material, conductive additives, and the solid electrolyte within the electrode composite layer 220, 280.

In general, higher pressures may be used to ensure uniform contact between the lithium-containing layer 230, 270 and the electrode composite layer 220, 280 to support more uniform initial lithiation. Additionally, as the silicon material lithiates, it becomes more ionically conductive. This may increase the ability of lithium to diffuse through the already lithiated silicon near the contacted surfaces between the layers and start alloying with the silicon further within the electrode composite. In this manner, lithium may propagate through the electrode composite, enabling faster lithiation.

Upon the application of sufficient compressive force, the silicon within the electrode composite 220, 280 may begin lithiation to form a silicon-lithium alloy. In some instances, a waiting period may be established to allow the lithiation of the electrode composite layer 220, 280 to occur. The waiting period or other parameter of the lithiation process may be predetermined or actively controlled based upon monitoring of the characteristics of the lithiating electrode composite. For example, if the lithium-containing layer 230, 270 is deposited upon a transparent substrate, the progress of the reaction may be monitored optically by transmissive or reflectometric measurement. Lithiation may also be monitored by electrical methods, including but not limited to, eddy current sensing and resistivity measurement to aid in determining an adequate lithiation of the electrode composite layer 220, 280.

Depending upon the degree of lithiation, thickness of layers, and pressure, lithiation may occur in a range from 1 to 600 minutes. In some embodiments, the electrode stack 102 may be under pressure for 0.01 to 1 minute ensuring contact between lithium-containing layer 230, 270 and the electrode composite layer 220, 280, at which time the pressure may be removed. The electrode stack 102 may be allowed to rest for 0.01 minutes to 600 minutes or until the desired degree of lithiation has been reached. In another embodiment, the electrode stack 102 may be under pressure for 0.01 to 600 minutes, ensuring contact between the lithium-containing layer 230, 270 and the electrode composite layer 220, 280 and allowing lithiation of the electrode to occur.

In one example, the contacted layers may be pressure loaded for sufficient time such that all of the lithium that is in the lithium-containing layer 230, 270 is transferred into the electrode composite layer 220, 280. The thickness of the lithium-containing layer 230, 270 may be chosen such that all lithium metal in the lithium-containing layer is consumed in the electrode composite layer 220, 280 when the desired level of prelithiation is reached. An electrode composite layer 220, 280 may include both lithiated (silicon-lithium alloy) and non-lithiated (silicon metal) silicon and the fraction of lithiated vs non-lithiated silicon may be controlled by how much lithium is introduced to the surface of the electrode composite. Increased reaction times may be substituted, in some instances, for higher pressures to ensure complete reaction of lithium metal with the electrode composite layer 220, 280. For example, similar consumption of lithium may be achieved using approximately 12,000 psi with a 60 second duration or 8,000 psi and a 180 second duration. Relatedly, using 12,000 psi, lithium consumption may be approximately 3 microns/minute. Further, the above operations of method 300 may occur within an ambient or layer temperature range of approximately 0 to 180 Celsius. Although lithiation may generally occur at higher rates with higher temperatures, the above operations may be configured to balance reaction kinetics for lithiation based upon decreasing processing time and resultant mechanical properties of the prelithiated electrode composite. For example, excessive temperature may result in a very rapid lithiation with degraded mechanical stability (cracking) of the prelithiated electrode composite. Alternatively, a temperature range between 25 and 100 Celsius or between 25 and 75 Celsius may be used.

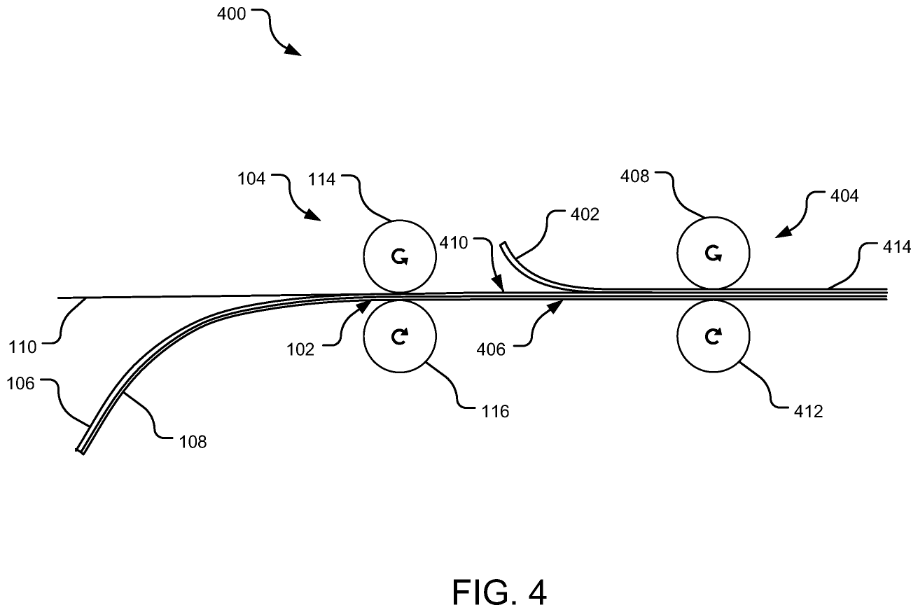

As an alternative to the use of an independent lithium-containing layer 230, 270, a thin film of lithium-containing material may be deposited directly onto the surface of the electrode composite layer 220, 280 using a technique such as evaporation (PVD, CVD, ALD). Alternatively, lithium metal can first be deposited onto a solid electrolyte separator layer. The lithium may be transferred from the solid electrolyte separator to the electrode composite layer 220, 280 when the separator is laminated to the electrode composite using applied pressure from a calender or linear press (discussed in more detail below). Alternatively, lithium may be in the form of particles such as SLMP (stabilized lithium metal powder). This SLMP may be mixed into the electrode composite or coated on top of the electrode composite layer.

Where a carrier material, such as copper, was used with the lithium-containing layer 230, 270, the carrier may be subsequently removed from the surface of the electrode stack in operation 308. In some instances, some lithium of the lithium-containing layer may remain adhered to the carrier material as not absorbed by the electrode composite layer. In such circumstances, removal of the carrier from the surface of the electrode stack may further remove some or all of the remaining lithium-containing layer 230, 270 not absorbed during the calendering process. At operation 310, the exposed prelithiated electrode composite layer 220, 280 may be brought into contact with a separator layer. For example, FIG. 4 is a diagram 400 illustrating manufacturing a prelithiated electrode using a calender press and a peeler device. Several elements of the diagram 400 are similar to that discussed above with reference to FIG. 1. For example, an electrode stack 102 is shown comprising an electrode composite 106, a metal current collector 108, and a lithium-containing layer 110. The electrode stack 102 may be provided in a Lithium-Electrode-Current Collector configuration 200 (as illustrated in FIG. 2A) or in an Electrode-Lithium-Current Collector configuration 250 (as illustrated in FIG. 2B). As also discussed above, the electrode stack 102 may be fed through a calender press device 104 to prelithiate the electrode layer 106 with the lithium-containing layer 110. The calender press device 104 may include a top roller 114 and a bottom roller 116 to press at least a portion of the lithium of the lithium-containing layer 110 into the electrode layer 106, thereby transferring some lithium ions into the electrode layer. As also mentioned above in relation to operation 308 of FIG. 3, any remaining lithium-containing layer 110 may be removed from the stack, although such an operation is not shown in FIG. 4.

Regardless, the prelithiated stack 406 may be brought into contact with a separator layer 402, also referred to as a solid-state electrolyte layer. In general, the separator layer 402 may be brought into contact with the exposed side 410 of the prelithiated electrode composite layer. The separator layer 402 may comprise, in some instances, a sulfide-based solid electrolyte material and binder. Further, in some implementations, the separator layer 402 may be coated as a thin layer on a carrier film, such as an aluminum foil, although other materials may be used. The separator layer 402 may conduct ions, but not electrons, during use in a battery cell such that the separator layer provides electrical isolation for the prelithiated electrode composite layer 410.

At operation 312, the prelithiated stack 406, with the separator layer 402 in contact with the prelithiated electrode layer 410, may be fed through a second calender press 404 for additional pressing. The pressure applied by the second calender press 404 may laminate the separator layer 402 to the prelithiated electrode layer 410, at least partially adhering the separator layer to the prelithiated electrode layer. In some implementations, the prelithiated stack 406 may be fed through the first calender press 104 such that a second press 404 is not needed. Regardless, the laminated electrode stack 414, including the separator layer 402, may be utilized in an electrochemical cell as an anode or cathode of the cell. The prelithiation of the electrode layer 410 may remove the need for a formation step discussed above while increasing the efficiency of the lithium transfer between the electrodes of the electrochemical cell in comparison to non-prelithiated electrodes.

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

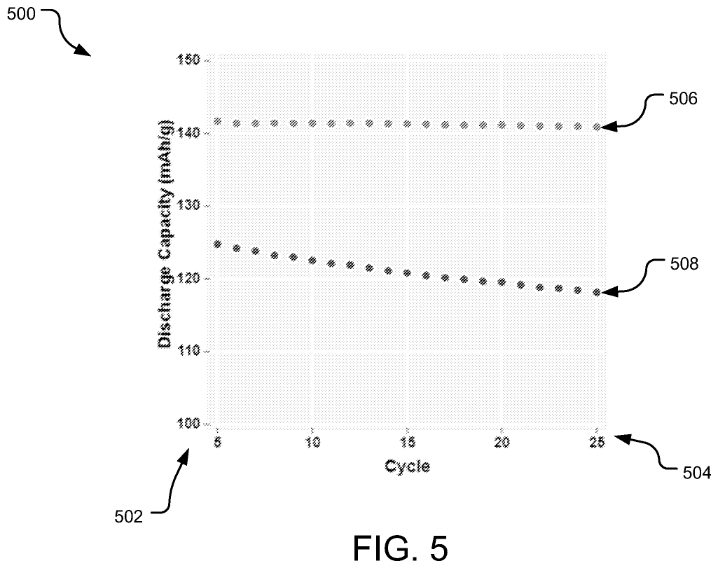

In a first example, an anode was prelithiated based on the systems and methods described herein and then formed into an electrochemical cell including the prelithiated anode. A comparative non-prelithiated anode was also generated and then formed into an electrochemical cell. The performances of the cell and associated prelithiated anode and the cell with the non-prelithiated anode were measured, with Table 1 providing comparative information. FIG. 5 illustrates a graph 500 of discharge capacity 502 versus a number of cycles 504 of the electrochemical cells including the prelithiated anode (line 506) and the non-prelithiated anode 508 (line 508). The performance data in Table 1 illustrates various properties of the prelithiated anode (and associated cell) and the non-prelithiated anode (and associated cell) used to generate the results illustrated in the graph 500 of FIG. 5. In particular, Table 1 illustrates a weight percentage of silicon, a degree of prelithiation, a discharge capacity, a ratio of the areal measurement of the anode to the areal measurement of the cathode (A:C ratio), a First Cycle Efficiency (FCE), and a weight percent of solid electrolyte in the anode for each of the prelithiated and non-prelithiated anodes illustrated in FIG. 5. A stack pressure of 1500 PSI was applied during the cell cycles for each of the samples.

TABLE 1

| | | | | | | Percent |
|---|---|---|---|---|---|---|
| | | Degree | | | | Solid |
| | Percent | of Pre- | | | First | Electro- |
| | Si in | lithia- | Discharge | | Cycle Ef- | lyte in |
| | Anode | tion | Capacity | | ficiency | Anode |
| | (%) | (%) | (mAh/g) | A:C | (%) | (%) |
| Prelithi- | 50 | 15 | 145 | 1.72 | 93.9 | 40 |
| ated Anode | | | | | | |
| Non-Pre- | 50 | 0 | 137 | 1.74 | 88.1 | 40 |
| lithiated | | | | | | |
| Anode | | | | | | |

As can be seen from the cycling data illustrated in the graph 500 and Table 1, the anode prelithiated using the methods described herein had consistently higher discharge capacity 506 compared to the non-prelithiated anode discharge capacity 508, everything else being equal. Further, the prelithiated anode also exhibited better stability at 1500 psi stack pressure and a first cycle efficiency over 90% as compared to a similar anode that had not been prelithiated—more than 5% greater first cycle efficiency

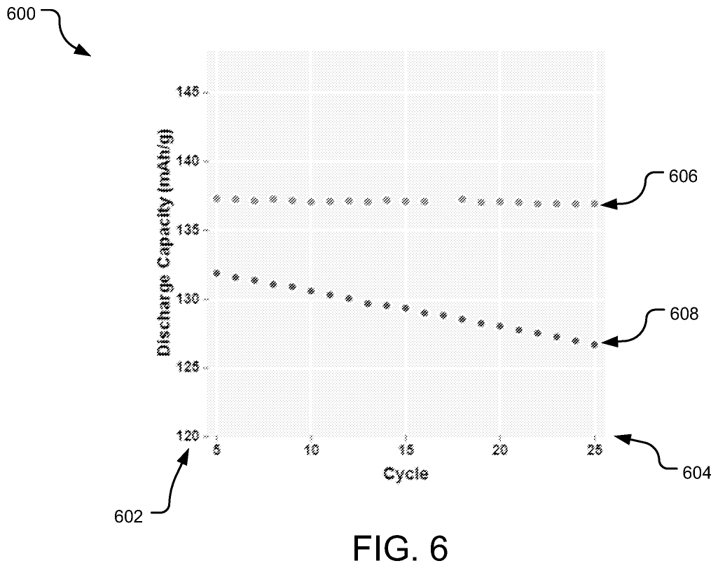

FIG. 6 illustrates a second graph and example of a discharge capacity 602 versus a number of cycles 604 of an electrochemical cell including a prelithiated anode 606 versus a cell with a non-prelithiated anode 608. Table 2 illustrates various properties of the cell and prelithiated anode and the cell and non-prelithiated anode used to generate the results illustrated in the graph 600 of FIG. 6, similar to above. A stack pressure of 1500 PSI was applied during the first cell cycle for each of the samples in Table 2. The A:C ratio of the cells in the first example was greater than 1.5 whereas the A:C ratio of the cells in the second example is less than 1.5 (and greater than 1).

TABLE 2

| | | | | | | Percent |
|---|---|---|---|---|---|---|
| | | Degree | | | | Solid |
| | Percent | of Pre- | | | First | Electro- |
| | Si in | lithia- | Discharge | | Cycle Ef- | lyte in |
| | Anode | tion | Capacity | | ficiency | Anode |
| | (%) | (%) | (mAh/g) | A:C | (%) | (%) |
| Prelithi- | 50 | 15 | 139.7 | 1.10 | 93.9 | 40 |
| ated Anode | | | | | | |
| Non-Pre- | 50 | 0 | 136.8 | 1.14 | 90.7 | 40 |
| lithiated | | | | | | |
| Anode | | | | | | |

As with the first example, as shown in the cycling data illustrated in the graph 600, the cell including an anode prelithiated using the methods described herein had consistently higher discharge capacity 606 compared to a cell with a non-prelithiated anode. Further, the prelithiated anode also exhibited better stability at 1500 psi stack pressure and a first cycle efficiency higher (over 93)% as compared to a similar anode that had not been prelithiated (90.7%).

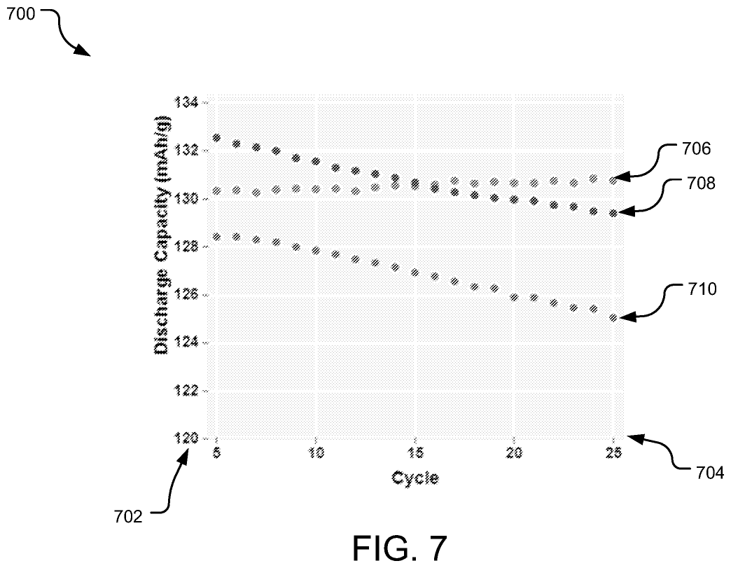

A third set of examples is illustrated in graph 700 of FIG. 7. Here, the graph illustrates a discharge capacity 702 versus a number of cycles 704 of electrochemical cells including a first prelithiated anode 706, a second prelithiated anode 708, and a non-prelithiated anode 710, respectively. As shown in Table 3 below, the first prelithiated anode 706 includes a 30% prelithiation, the second prelithiated anode 708 has a 15% prelithiation, and the non-prelithiated anode has a 0% prelithiation. Other properties of the prelithiated anodes and the non-prelithiated anode are also shown in Table 3. Similar to above, the stack pressure during the first cell cycle for each of the samples in Table 2 was applied at 1500 psi. In the examples of FIG. 7 and Table 3, the A:C rations are 1.21, 1.13 and 1.24 for the cells with the first, second and non-prelithiated anodes, respectively.

TABLE 3

| | | | | | | Percent |
|---|---|---|---|---|---|---|
| | | Degree | | | | Solid |
| | Percent | of Pre- | | | First | Electro- |
| | Si in | lithia- | Discharge | | Cycle Ef- | lyte in |
| | Anode | tion | Capacity | | ficiency | Anode |
| | (%) | (%) | (mAh/g) | A:C | (%) | (%) |
| First Pre- | 85 | 30 | 135.3 | 1.21 | 93.3 | 0 |
| lithiated | | | | | | |
| Anode | | | | | | |
| Second Pre- | 85 | 15 | 136.4 | 1.13 | 94.6 | 0 |
| lithitated | | | | | | |
| Anode | | | | | | |
| Non-Pre- | 85 | 0 | 135.1 | 1.24 | 89.2 | 0 |
| lithiated | | | | | | |
| Anode | | | | | | |

The graph 700 shows that the cells with the first prelithiated anode 706 and the second prelithiated anode 708 had consistently higher discharge capacities as compared to the cell with the non-prelithiated anode 710. Further, although the second prelithiated anode 708 had a higher discharge capacity than the first prelithiated anode (136.4 mAh/g compared to 135.3 mAh/g as shown in Table 3), the first prelithiated anode 706 had a more consistent discharge capacity than the second prelithiated anode 708 over the course of the cycles 704, eventually achieving a higher discharge capacity. As such, a modestly lower initial prelithiation percentage may correspond to a more consistent (or more desirable) electrochemical performance of the anode over the lifespan of an electrochemical.

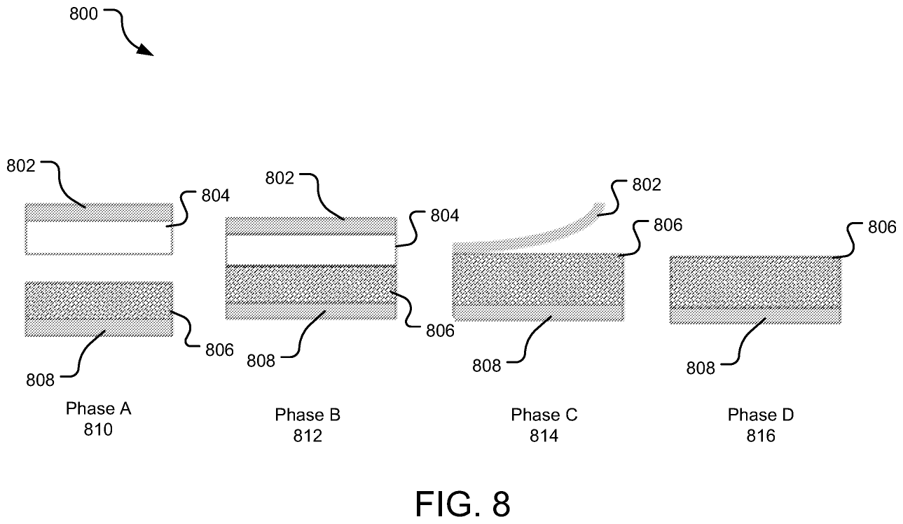

FIG. 8 illustrates a representative cross-section 800 of an electrode stack through a process of forming a cell using a prelithiated electrode for an electrochemical cell that includes a carrier foil adjacent to a lithium layer. As explained above, the electrode stack, as illustrated in Phase A (810) of the prelithiation process 800, may include a current collector layer 808 adjacent to an electrode composite layer 806 and a lithium-containing layer 804. The current collector layer 808, electrode composite layer 806, and lithium-containing layer 804 may include materials discussed above for the respective layers. In addition, a carrier layer 802, such as a metal foil, may be adjacent to the lithium-containing layer 804 and opposite the surface of the lithium-containing layer that contacts the electrode composite layer 806. In Phase B 812, the lithium-containing layer 804 may be positioned in contact with the electrode composite layer 806 to begin the prelithiation of the electrode composite layer. As explained above, at least a portion of the lithium-containing layer 804 may be absorbed into the electrode composite layer 806 and, in some instances, the entirety of the lithium-containing layer may be absorbed by the electrode composite layer, such as that shown in Phase C 814. In some implementations, prelithiation of the electrode composite layer 806 may include compressing the electrode stack with the lithium-containing layer 804 in contact with the electrode composite 806. During this compression, lithium from the lithium-containing layer 804 alloys with the material of the electrode composite 806 to prelithiate the electrode.

In general, the carrier layer 802 may protect the newly lithiated electrode layer 806 from air and moisture, which may degrade the bare electrode surface, during and after the lithiation process. Prior to inclusion in an electrochemical cell, the protective carrier layer 802 may be removed from the electrode composite layer 806 through a peeling process and the remaining layers of the stack, illustrated in Phase D 816, may be included as an electrode in an electrochemical cell.

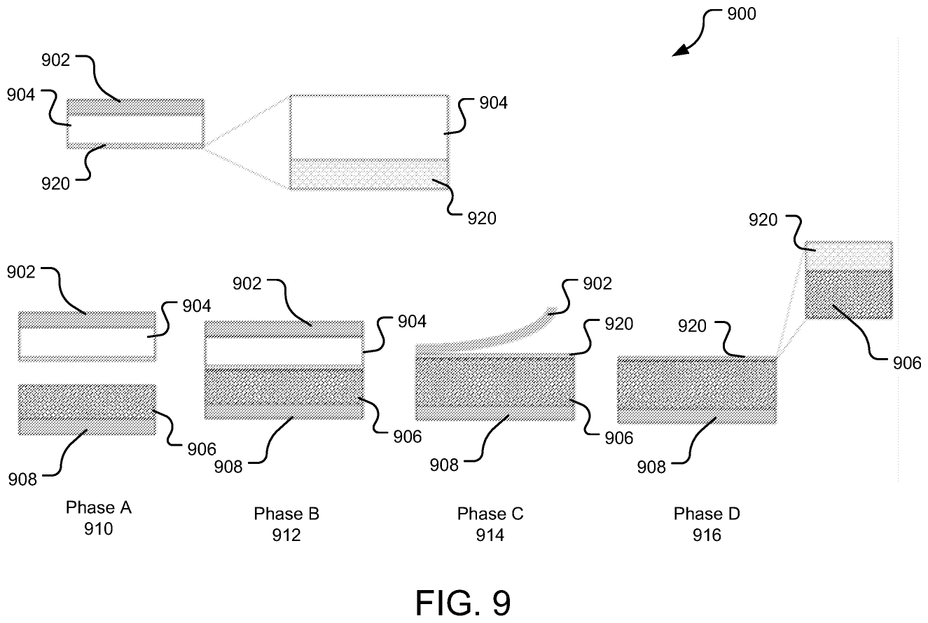

FIG. 9 illustrates representative cross-sections 900 of an electrode stack through a process for forming a prelithiated electrode for an electrochemical cell that includes a passivation layer. Many of the layers of the electrode stack illustrated in the cross-sections 900 are the same as those described above with regard to FIG. 8. In particular, the electrode stack may include a current collector layer 908 adjacent to an electrode composite layer 906 and a lithium-containing layer 904 adjacent to a carrier layer 902. However, in this implementation, the lithium-containing layer 904 may be adjacent the carrier layer 902 on one surface and a passivation layer 920 on the opposite surface. In some implementations, the passivation layer 920 may comprise one or more of a Li₂CO₃, Li2O, Li₃N, or LiOH. In Phase B 912 of the illustrated process, the lithium-containing layer 904 (as sandwiched or otherwise positioned between the carrier layer 902 and the passivation layer 920) is brought into contact with the electrode composite layer 906, with the passivation layer positioned between the lithium-containing layer and the electrode composite layer. In Phase C, the lithium-containing layer 904 may be absorbed into the electrode composite layer 906 through the passivation layer, such as that shown in Phase C 914. In particular, during the compression of the stack, lithium from the lithium-containing layer 904 defuses through the passivation layer 920 and alloys with the electrode composite material resulting in a prelithiated electrode layer 906 with a lithium rich passivation layer 920 on top of the electrode composite layer. The carrier layer 902 may also remain after lithiation of the electrode composite layer 906 and may be removed from the stack, as illustrated in Phase C 914. Once the carrier layer 906 is removed, a prelithiated electrode remains with a passivation layer 920 coating the outer surface of the electrode 906 opposite the current collector layer 908. This passivation layer 920 may further protect the newly lithiated electrode layer 906 from air and moisture, which may degrade the bare electrode surface, during and after the lithiation process.

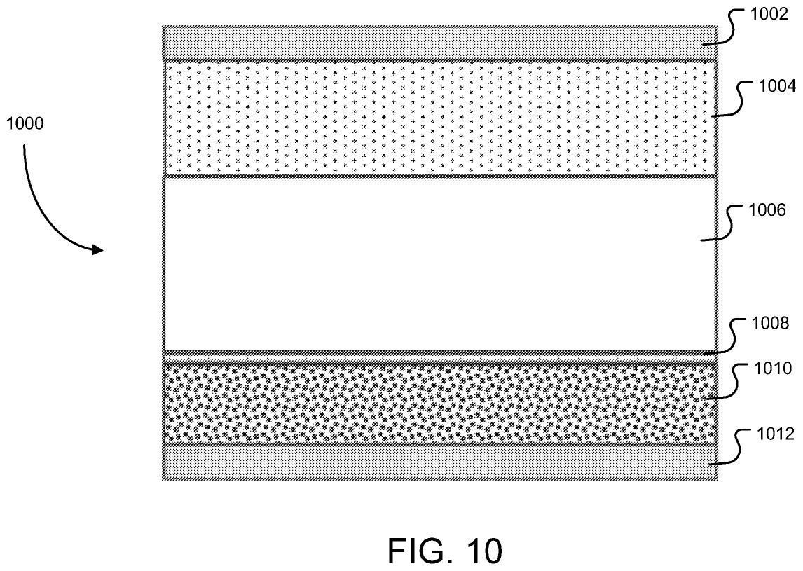

The electrode stack including the passivation layer 920 may be used in an electrochemical cell. In particular, FIG. 10 illustrates a representative cross-section of an electrochemical cell 1000 that includes a prelithiated anode with a passivation layer generated through the process described above. The cell 1000 comprises several layers, namely a cathode current collector 1002, a cathode electrode 1004, a separator layer 1006 (e.g., solid state electrolyte (SSE) layer), a passivation layer 1008, a prelithiated anode layer 1010, and an anode current collector layer 1012. In this arrangement, the passivation layer 1008 is between the prelithiated anode layer 1010 and the separator layer 1006 when assembled into an electrochemical cell. In some circumstances, the passivation layer 1020 may prevent the lithiated anode layer 1010 from reacting with the solid electrolyte layer 1006 as the passivation layer remains stable between the anode and the separator layer. In this manner, the protective passivation layer 1020 may be integrated into the stack of the electrochemical cell as an additional protective barrier for one or both of the electrodes of the cell.

Referring again to FIG. 9, in some implementations, a lithium alloy may be used in the lithium-containing layer 904. In this case, lithium alloying components (Sodium, Potassium, Aluminum, Magnesium, Calcium, etc.) may not alloy with the electrode composite material. Instead, only the lithium may be drawn out of the lithium alloy to prelithiate the electrode composite layer 904. When all of the lithium is consumed through the lithiation process, what remains is a layer of the other components of the alloy. This layer 920 may remain on the surface of the electrode composite layer 906 much like the passivation layer. When this anode is assembled into an electrochemical cell, the passivation layer 1008 of FIG. 10 may include a metal alloying layer containing one of more of a metal such as Sodium, Potassium, Aluminum, Magnesium, Calcium, etc. from the lithium-containing layer 904. This metal alloying layer may be positioned between the anode 1010 and the separator layer 1006. In general, this metal layer does not alloy with the material of the anode 1010 and can act as a “soft” interfacial layer between the anode and the separator layer 1006 to improve ionic contact between the layers.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

What is claimed is:

1. A method for manufacturing a battery electrode, the method comprising:
disposing a continuous layer of lithium adjacent to an electrode composite of an electrode stack; and
pressing the continuous layer of lithium to the electrode composite to prelithiate the electrode composite with at least a portion of the continuous layer of lithium.

2. The method of claim 1, further comprising:
disposing a separator layer onto the electrode stack adjacent to the prelithiated electrode composite, the separator layer comprising a solid-state electrolyte.

3. The method of claim 1 wherein pressing the continuous layer of lithium to the electrode composite comprises:
feeding the electrode stack through a calender press comprising a first roller and a second roller, the first roller oriented above the second roller and separated by a pressing spacing, the pressing spacing based on a thickness of at least one layer of the electrode stack.

4. The method of claim 1 wherein the electrode composite comprises a silicon-containing material, a carbon-based conductive additive, a solid electrolyte, and a binder.

5. The method of claim 1 wherein the continuous layer of lithium is pressed to the electrode composite with a pressure of about 1,500 to 100,000 psi.

6. The method of claim 1 wherein the continuous layer of lithium is pressed to the electrode composite for a duration of between 0.01 and 60 minutes.

7. The method of claim 1 wherein the continuous layer of lithium has a thickness in the range of 0.1 to 20 microns.

8. The method of claim 1 wherein the continuous layer of lithium comprises a lithium alloy, the pressing of the continuous layer of lithium to the electrode composite transferring at least a portion of lithium ions of the lithium alloy to the electrode composite.

9. The method of claim 1, further comprising:
casting the continuous layer of lithium upon a carrier foil; and
removing the carrier foil from the continuous layer of lithium after the pressing of the continuous layer of lithium to the electrode composite.

10. The method of claim 9 wherein when the carrier foil comprises a copper foil.

11. The method of claim 1 wherein the continuous layer of lithium comprises a passivation layer adjacent to the electrode composite, the passivation layer remaining after pressing the continuous layer of lithium to the electrode composite.

12. The method of claim 1, further comprising:
monitoring a state of lithiation of the electrode composite during the pressing of the continuous layer of lithium to the electrode composite; and
adjusting, based on the monitoring of the state of lithiation of the electrode composite, a parameter of the pressing of the continuous layer of lithium to the electrode composite.

13. A solid-state electrochemical cell comprising:
a first electrode;
a solid-state electrolyte adjacent the first electrode; and
a second electrode adjacent the solid-state electrolyte, wherein the second electrode is prelithiated by dry laminating a continuous layer of lithium to a second electrode composite.

14. The solid-state electrochemical cell of claim 13 wherein the second electrode is dry laminated through a calender press comprising a first roller and a second roller, the first roller oriented above the second roller and separated by a pressing spacing.

15. The solid-state electrochemical cell of claim 12 wherein at least a portion of the continuous layer of lithium is absorbed into the second electrode composite to prelithiate the second electrode.

16. The solid-state electrochemical cell of claim 12 wherein the continuous layer of lithium has a thickness in the range of 0.1 to 20 microns before dry laminating.

17. The solid-state electrochemical cell of claim 13 wherein the continuous layer of lithium includes a lithium alloy.

18. The solid-state electrochemical cell of claim 13 wherein the continuous layer of lithium is positioned proximate a surface of the second electrode composite opposite a current collector.

19. A method for manufacturing a battery electrode, the method comprising:
compressing an electrode stack comprising an electrode composite, a current collector, and a continuous layer of lithium adjacent to the electrode composite, wherein at least a portion of the continuous layer of lithium is absorbed by the electrode composite during the compression to prelithiate the electrode composite.

20. The method for manufacturing the battery electrode of claim 19 wherein the continuous layer of lithium of the electrode stack is disposed between the electrode composite and the current collector.

21. The method for manufacturing the battery electrode of claim 19 wherein the electrode composite of the electrode stack is disposed between the continuous layer of lithium and the current collector.

22. The method for manufacturing the battery electrode of claim 19 wherein the electrode composite comprises a range of 1% to 15% prelithiation.

23. The method for manufacturing the battery electrode of claim 19 wherein the electrode composite comprises a range of 15% to 30% prelithiation.
